(19) United States
(12) Patent Application Publication
(10) Pub. No.: US 2011/0025581 A1
(43) Pub. Date: Feb. 3, 2011

(54) ANTENNA ASSEMBLY

(76) Inventors: David John Geer, Johnsonburg, PA (US); Theodore Joseph Krellner, Emporium, PA (US)

Correspondence Address: General Electric Company;GE Global Patent Operation, 2 Corporate Drive, Suite 648, Shelton, CT, 06484, US

(21) Appl. No.: 12/533,186

(22) Filed: Jul. 31, 2009

(51) Int. Cl. H01Q 1/50

(52) U.S. Cl. 343/906

(57) ABSTRACT

An antenna configured so as to use a transmitting or receiving element as the center conductor of a connector interface, which can connect to other connectors such as coaxial cable connectors. In one embodiment, the antenna comprises an antenna body that has an antenna connector configured as a reverse polarity connector. The reverse polarity connector comprises features which can position the transmitting or receiving element in direct contact with the center conductor of a mating cable.

### BACKGROUND OF THE INVENTION

The present invention relates to signal transmitting and receiving devices, and more particularly, to antennas with connective elements that interface with cable connectors, e.g., coaxial cable connectors, in a manner that reduces variability amongst antennas having the same construction.

Devices for transmitting or receiving signals such as antennas are used in many applications including applications where the attenuation level of a signal is measured as between two antennas. For example, the attenuation of a radio frequency (“RF”) signal can be used to monitor certain performance characteristics of filters such as diesel particulate filters (“DPF filters”), and related DPF filter systems. These systems deploy antennas on either side of a filter, cause an RF signal to be exchanged between the antennas, and process a measured RF signal to identify the attenuation that results from particulate build-up in the filter.

Typically these systems are configured to calibrate noise, and other system inconsistencies so as to manage the overall performance, reliability, and quality of the data collected, e.g., during operation of the DPF filter system. This calibration can take into account, for example, reflection of the RF signal that occurs as a result of the construction of the various components, e.g., the cables, cable connectors, and the antennas. But this calibration takes time and resources, in effect reducing the efficiency of operation of the equipment on which the DPF system is utilized. It is also likely that such calibration can require specific equipment and technical knowledge, both of which are not necessarily available or cost effective to provide on-site.

Moreover, calibration and other techniques only mask problems. They do nothing to address the limitations and flaws of the underlying components. These limitations include the reflection of the RF signal in the various components, and more particularly the reflection that occurs in and around the antenna, the cable, and the antenna-cable interface.

Therefore, there is a need to reduce the reflective characteristics of the antenna so as to reduce the reliance on calibration techniques as they relate to measurement systems like the DPF filter systems mentioned above. It is likewise desirable to provide an antenna that is constructed in a manner so as to permit antennas to be replaced within the DPF filter systems. Still further there is a need to reduce the variability of signal conduction between the antenna and other mated devices, such as coaxial cables that are used in the DPF filer system.

### BRIEF DESCRIPTION OF THE INVENTION

In one embodiment, an antenna that comprises an antenna body with a transmitting or receiving end, a connective end opposite the transmitting or receiving end, and a longitudinal axis extending therebetween. The antenna also comprises an antenna connector disposed on the connective end, and a transmitting or receiving element aligned with the longitudinal axis. The transmitting or receiving element comprising an element body with a radiating portion extending out the transmitting or receiving end, and a connecting portion forming a center conductor of the antenna connector.

In another embodiment, an antenna that comprises an antenna body comprising a transmitting or receiving end, a connective end opposite the transmitting or receiving end, and a longitudinal axis extending therebetween. The antenna also comprises an antenna connector disposed on the connective end, the antenna connector comprising an interface comprising an elongated insulating member having an inner bore, and an outer shell in surrounding relation to the elongated insulating member. The antenna further comprises a transmitting or receiving element aligned with the longitudinal axis. The transmitting or receiving element comprising an element body with a radiating portion extending out the transmitting or receiving end, and a connecting portion extending into the inner bore of the elongated insulating member in a manner exposing the connecting portion as a center conductor of the antenna connector.

In yet another embodiment, a sensor that comprises a controller responsive to an RF signal, a cable coupled to the controller, and an antenna secured to the mating connector. The cable comprising a mating connector, and a conductor for conducting the RF signal between the controller and the mating connector. The antenna comprising an antenna body having a transmitting or receiving end, a connective end opposite the transmitting or receiving end, and a longitudinal axis extending therebetween. The antenna also comprises an antenna connector disposed on the connective end, the antenna connector for receiving the mating connector. The antenna further comprises a transmitting or receiving element aligned with the longitudinal axis, the transmitting or receiving element comprising an element body with a radiating portion extending out the transmitting or receiving end, and a connecting portion forming a center conductor of the antenna connector.

### BRIEF DESCRIPTION OF THE DRAWINGS

So that the manner in which the above recited features of the present invention can be understood in detail, a more particular description of the invention briefly summarized above, may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. The drawings are not necessarily to scale, emphasis generally being placed upon illustrating the principles of certain embodiments of invention.

Thus, for further understanding of the nature and objects of the invention, references can be made to the following detailed description, read in connection with the drawings in which:

FIG. 1 is a side view of an example of an antenna that is made in accordance with concepts of the present invention.

FIG. 2 is a side, cross-sectional view of another example of an antenna that is made in accordance with the present invention.

FIG. 3 is a schematic diagram of a sensor that comprises sensor electronics, connecting cables, and a pair of antennas, such as the antennas of FIGS. 1 and 2.

FIG. 4 is a schematic diagram of a DPF filter system that is configured to monitor the amount of soot in a filter of the DPF filter system, the DPF filter system comprises a pair of antennas such as the antennas of FIGS. 1 and 2.

### DETAILED DESCRIPTION OF THE INVENTION

There is provided below embodiments of an antenna that are configured to transmit and receive RF signals. Such embodiments are constructed in a manner that reduces, and effectively eliminates certain operating characteristics generally exhibited by antennas of this type so as to improve RF signal conduction via the antenna. These improvements are realized in some embodiments because the antenna has a reduced number of reflection points, which can cause the RF signal to reflect back towards one end of the antenna. Reflection can disrupt the RF signal conduction, reduce the sensitivity of the antenna, and lead to unacceptably high levels of variability among antennas.

These challenges, and in particular the variability between antennas, can be burdensome when the antennas are to be replaced, swapped, or otherwise exchanged with other antennas of the same or similar construction, such as is the case in certain systems and applications (e.g., sensor systems for diesel particulate filters). On the other hand, it will be discussed in more detail below that the antennas that are made in accordance with the concepts of the present invention reduce the variability from antenna to antenna to a level where each antenna can be replaced without effectively changing the performance of the system and/or application. This is particularly beneficial because these antennas can be implemented to collect measurements related to RF signal conduction, and more particularly to collect such measurements where the collected data must fall within specific tolerance levels that are not addressed by the antennas, or the systems discussed in the Background section above.

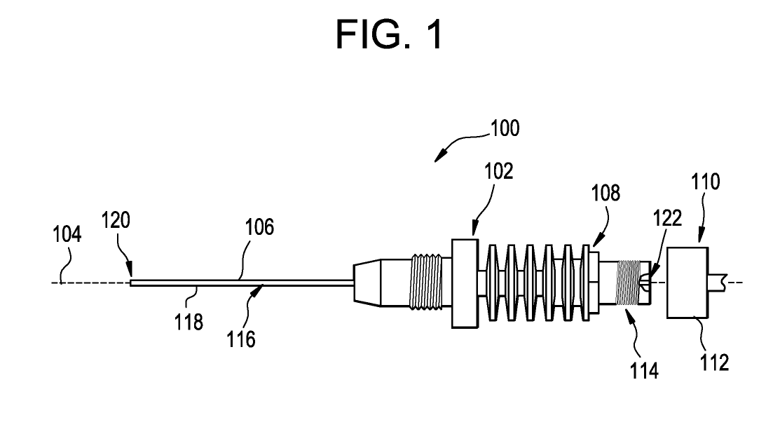

So with reference to the drawings generally, and FIGS. 1-4 in particular, embodiments of the antenna can be had, in which these embodiments are characterized so that the attenuation of the signal transmitted from one antenna, and received by another antenna can be measured with a reduced level of variability from antenna to antenna. With reference to FIG. 1, there is illustrated an example of an antenna 100 that is made in accordance with the concepts of the present invention. The antenna 100 can comprise an antenna body 102 with a longitudinal axis 104, a transmitting or receiving end 106, and a connective end 108 for receiving a cable 110 such as more particularly a cable connector 112 on the end of the cable 110. In one example, the antenna 100 can comprise an antenna connector 114, located on the connective end 108, and configured to interface with the cable connector 112.

The antenna 100 can also comprise a transmitting or receiving element 116, constructed in one embodiment of Inconel alloys and comparable materials. The transmitting or receiving element 116 has an element body 118 extending into the antenna body 102. The element body 118 can comprise a radiating portion 120, which extends out of the antenna body 102 on the transmitting or receiving end 106. The element body 118 can also comprise a connecting portion 122 (shown here in limited view), which is opposite the radiating portion 120 and proximate the antenna connector 114.

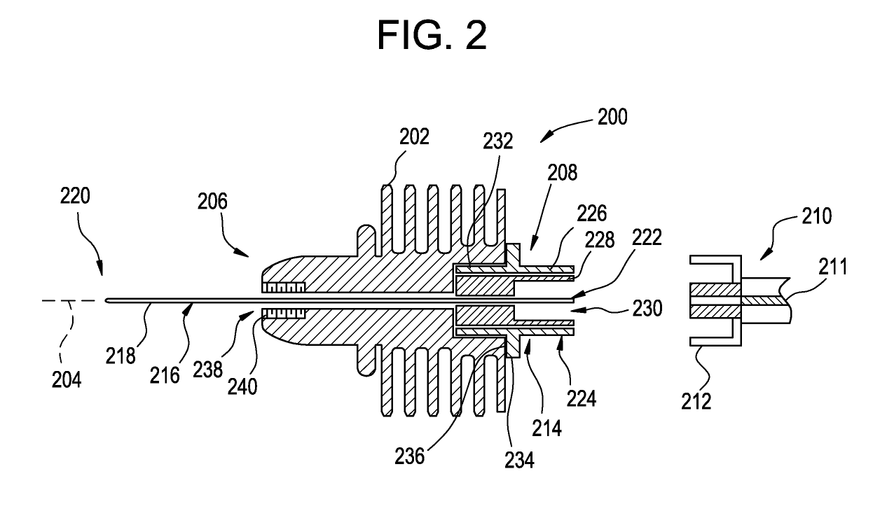

It is noted here, and also discussed and illustrated in connection with FIG. 2 below, that the connecting portion 122 extends into the antenna connector 114. This configuration permits the connecting portion 122 to be used as the center conductor of the antenna connector 114. This configuration eliminates one or more reflective points. Moreover, the connecting portion 122 can directly contact the center conductor of the cable 110, when the cable connector 112 and the antenna connector 114 are secured together. This direct contact permits signals (e.g., the RF signals) transmitted or received by the radiating portion 120 to be conducted directly to the center conductor of the cable 110.

Additional details of this concept, as well as other features and concepts of embodiments of the present invention are discussed below in connection with the example of an antenna 200, which is illustrated in FIG. 2. Here, like numerals are used to identify like components as between the antenna 100 of FIG. 1, except the numerals are increased by 100 (e.g., 100 is now 200). For example, it is seen in this embodiment that the antenna 200 can comprise an antenna body 202 with a longitudinal axis 204, and a transmitting or receiving end 206. The antenna body 202 can also comprise a connective end 208 for, e.g., receiving a cable 210 with a center conductor 211 via a cable connector 212. The antenna 200 can further comprise an antenna connector 214, a transmitting or receiving element 216 with an element body 218 that has a radiating portion 220, and a connecting portion 222, which is opposite the radiating portion 220.

The antenna connector 214 can comprise an interface 224, which in one construction has an outer shell 226 that surrounds an inner insulating member 228. In the present example, the insulating member 228 has a bore portion 230 that extends into the inner insulating member 228 from the connective end 208. By way of non-limiting example, the antenna body 202 can have a receptacle area 232 near the connective end 208, the receptacle area 232 being constructed in a manner that it can receive the antenna connector 214 therein. Embodiments of the antenna 200, for example, can be configured where the receptacle area 232 and the outer shell 226 have complementary threads, which engage in a manner that secures the antenna connector 214 to the antenna body 202.

In one example, the outer shell 226 can comprise a shoulder 234 with a shoulder surface 236, in which the position of the shoulder surface 236 can abut a part of the antenna body 202. This abutment can limit the extent to which the outer shell 226 is received in the receptacle area 232. It is likewise contemplated that the receptacle area 232 and the outer shell 226 can be sized and configured so as to secure the antenna connector 214 to the antenna body 202 without threads or other fastening implements (e.g., adhesives). The diameters of the outer shell 226 and the receptacle area 232, for example, can be selected so as to create interference, an interference fit, and/or a press-fit, as between the outer dimensions of the outer shell 226 and the inner dimensions of the receptacle area 232.

The interface 224, and in one example the outer shell 226 can be used to secure the cable connector 212 and the antenna connector 214. The interface 224 can be of standard variety such as is used with coaxial cables, and coaxial cable technology. Exemplary interfaces for use as the interface 224 can include, but are not limited to threaded surfaces, snap fittings, pressure release fittings, deformable fittings, quick-release fittings, and any combinations thereof. In one example, the interface 224 (and the cable connector 212, and the antenna connector 214) can comprise a reverse polarity connector, wherein the male portion resides on the antenna connector 214 and the female portion resides on the cable connector 212. In another example, the interface 224 (and one or both of the cable connector 212, and the antenna connector 214) are compatible with connectors selected from the group of connector interfaces consisting of a BNC connector, a TNC connector, an F-type connector, an RCA-type connector, a 7/16 DIN male connector, a 7/16 female connector, an N male connector, an N female connector, an SMA male connector, and an SMA female connector.

The bore portion 230 of the insulating member 228 can be likewise configured to receive the cable connector 212 such as if the reverse polarity connector is utilized to connect the cable 210 to the antenna body 202. In one example, the diameter of the bore portion 230 is sized to receive the inner portion of one of the connectors discussed immediately above. This inner portion may comprise a complementary cylindrical shape, and in one implementation the inner portion is sized to fit inside of the bore portion 230, so as to be in surrounding relation to the connecting portion 222 of the element body 218.

The antenna body 202 can further comprise a seal area 238, which is opposite the receptacle area 232, and for receiving a seal 240. Seals of the type used as the seal 240 are generally constructed so as to fit in surrounding relation to the element body 218, such as by providing an aperture through the seal 240 that is sized to fit over and around the element body 218. A variety of materials can used for the seal 240, with one construction of the seal 240 comprising one or more slugs of glass and/or similar silica-based materials, which is inserted into the seal area 238 and melted to form the seal, e.g., an air-tight seal.

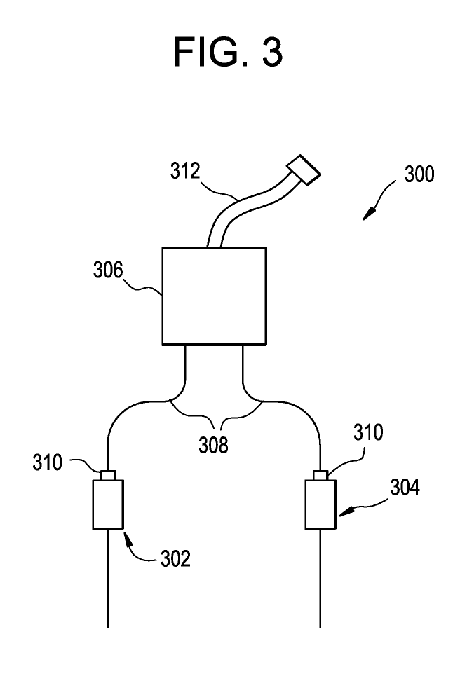

Discussing next an implementation of embodiments of the antennas, such as the antennas 100, 200 described above, FIG. 3 illustrates an example of a sensor 300 that comprises a first antenna 302 and a second antenna 304, both of which can be made in accordance with concepts of the present invention. The sensor 300 also comprises a controller 306, and cables 308 with connectors 310 that interface with the first antenna 302 and the second antenna 304 (“the antennas”). This interface places the center conductor of the cable in direct contact with the transmitting or receiving element of the first antenna 302 and the second antenna 304. The sensor 300 further comprises an interface cable 312 such as would be used to interface with, e.g., a computer, a laptop, and/or an equipment condition monitoring (“ECM”) device.

At a high level, in one embodiment the sensor 300 is configured to cause one of the antennas to transmit a signal such as an RF signal, and to respond to the RF signal as that signal is received by the other, non-transmitting antenna. The RF signal can have frequency that is greater than about 500 mHz, with one particular operation of the sensor 300 providing the frequency from about 700 mHz to about 900 mHz. This frequency is particularly useful in connection with the DPF filters discussed above, an example of which is provided immediately below.

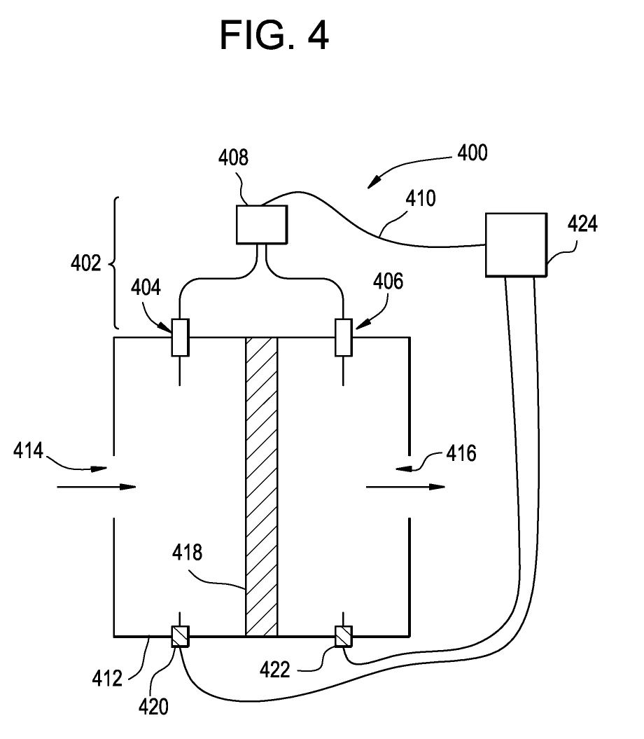

That is, and with reference to FIG. 4, an example of a DPF filter system 400 comprises a sensor 402 with a first antenna 404, a second antenna 406, a controller 408, and an interface cable 410. The DPF filter system 400 also comprises a filter body 412 with an input side 414 and an output side 416. Inside of the filter body 412 is provided a filter 418, wherein the filter 418 in preferred embodiments of the system 400 can be constructed of materials that are selected for their compatibility with diesel exhaust, and diesel exhaust particulates generated by diesel engines. The DPF filter system 400 can also comprise a first temperature sensor 420, a second temperature sensor 422, and an ECM device 424, which is coupled to each of the sensor 402, the first temperature sensor 420, and the second temperature sensor 422.

During operation of the DPF filter system 400 (and, also the sensor 402), diesel exhaust impinges on the filter 418 as the exhaust flows from the input side 418 to the output side 416 of the filter body 412. Based on the construction of the filter 418, particulates are trapped in the material of the filter 418, which clogs the material so as to effectively retard the flow of the diesel exhaust through the filter 418. It is recognized that as more particulates become bound in the material of the filter 418, the effect is to reduce the flow of exhaust through the filter 418 in a manner that can deleteriously impact, e.g., the diesel engine connected to the DPF filter system 400.

Sensor 402 is provided, however, so as to monitor the clogging of the filter 418. In one embodiment, an RF signal is transmitted from the first antenna 404, and received by the second antenna 406. The ECM device 424 is configured, typically with an algorithm or other logical circuitry, to compare properties of the transmitted RF signal to properties of the received RF signal so as to determine the level of clogging that has occurred during operation of the filter 418. In one example, this property is the amount of power of the signal, so that the amount of power of the transmitted RF signal is compared to the amount of power of the received RF signal. More particularly, the ECM device 424 is configured to measure the attenuation of the RF signal as between the transmitted RF signal and the received RF signal. The attenuation, in combination with temperature data that is monitored and collected by the temperature sensors 420, 422 can be used to monitor clogging of the DPF filter 400.

### EXPERIMENTAL EXAMPLES

In view of the foregoing, it is further noted that antennas of the type disclosed and contemplated herein can be readily replaced in the DPF filter systems because of the limited variability between such antennas. To exemplify this favorable level of variability, reference is had to the experimental data collected from experiments conducted in a system that is similar to the DPF filter system 400 discussed above. That is, an RF signal having a frequency swept between 700 mHz and 900 mHz was transmitted from a first antenna positioned on one side of a filter in a DPF filter system, and received at a second antenna on the other side of the filter. The level of attenuation was measured, as between the transmitted RF signal and the received RF signal.

Table 1 below summarizes data collected from nine (9) separate antennas, each of the nine antennas being constructed in accordance with the concepts of the present invention so as to have the transmitting or receiving element being used as the center conductor of the antenna connector, which forms a “one-piece” construction.

TABLE 1

| | Average | Median | Std. Dev. | S21 @ | |
|---|---|---|---|---|---|
| | Power | Power | Power | F = 774 | S21 @ |
| Antenna | Loss | Loss | Loss | MHz | F = 854 MHz |
| 1 | −19.3180 | −18.7082 | 3.7160 | −22.3543 | −13.9434 |
| 2 | −19.3441 | −18.7214 | 3.7139 | −22.3790 | −13.9733 |
| 3 | −19.3841 | −18.7649 | 3.7461 | −22.4469 | −13.9815 |
| 4 | −19.4162 | −18.7949 | 3.7279 | −22.4479 | −14.0315 |
| 5 | −19.2462 | −18.6518 | 3.7163 | −22.2863 | −13.8785 |
| 6 | −19.2747 | −18.6769 | 3.7195 | −22.3138 | −13.8997 |
| 7 | −19.4051 | −18.7808 | 3.7325 | −22.4482 | −14.0114 |
| 8 | −19.3386 | −18.7081 | 3.7523 | −22.3881 | −13.9267 |
| 9 | −19.2958 | −18.6542 | 3.7343 | −22.3445 | −13.9152 |

Table 2 below summarizes the data collected for the nine (9) separate antennas of Table 1, and compares this data to data collected for fifteen (15) separate antennas operated under similar conditions, but with the antenna having a separate center conductor in the antenna connector, which forms a “two-piece” construction.

TABLE 2
S21 over frequency range of 700 mHz to 900 mHz

| | Mean | Std. Dev. | Range |
|---|---|---|---|
| Average S21 | | | |
| New Antenna | −19.340 | 0.059 | 0.170 |
| Existing Antenna | −19.260 | 0.265 | 0.910 |
| Std. Dev. S21 | | | |
| New Antenna | 3.730 | 0.014 | 0.038 |
| Existing Antenna | 3.960 | 0.052 | 0.170 |

Examining the data of Tables 1 and 2 it is seen that the performance of antennas where the transmitting and receiving element is used as the center conductor of the antenna connector is superior to antennas that utilize a separate center conductor. For example, it is seen that the range and standard deviation of values for the average S21 is far less for the antenna that is made in accordance with the present invention. This lower value not only indicates superior performance over the antenna with separate center conductor, but also that the variability previously seen in such antenna is effectively reduced.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An antenna comprising:
an antenna body comprising a transmitting or receiving end, a connective end opposite the transmitting or receiving end, and a longitudinal axis extending therebetween;
an antenna connector disposed on the connective end; and
a transmitting or receiving element aligned with the longitudinal axis, the transmitting or receiving element comprising an element body with a radiating portion extending out the transmitting or receiving end, and a connecting portion forming a center conductor of the antenna connector.

2. An antenna according to claim 1, wherein the antenna connector comprises an interface with a threaded surface.

3. An antenna according to claim 2, wherein the interface comprises an outer shell in surrounding relation to the connecting portion of the element body, and an insulating member disposed in the outer shell, the insulating member for insulating the connecting portion from the outer shell.

4. An antenna according to claim 1, wherein the antenna connector comprises a reverse polarity connector, and wherein the center conductor forms a male portion of the reverse polarity connector.

5. An antenna according to claim 1, further comprising a seal disposed on the transmitting or receiving end of the antenna body, the seal comprising an aperture in surrounding relation to the element body.

6. An antenna according to claim 1, wherein the element body comprises a nickel-chromium alloy.

7. An antenna according to claim 1, wherein the antenna connector comprises a TNC connector.

8. An antenna according to claim 1, wherein the connector end comprises a receptacle area that has an inner threaded surface for engaging a portion of the antenna connector.

9. An antenna comprising:
an antenna body comprising a transmitting or receiving end, a connective end opposite the transmitting or receiving end, and a longitudinal axis extending therebetween;
an antenna connector disposed on the connective end, the antenna connector comprising an interface comprising an elongated insulating member having an inner bore, and an outer shell in surrounding relation to the elongated insulating member; and
a transmitting or receiving element aligned with the longitudinal axis, the transmitting or receiving element comprising an element body with a radiating portion extending out the transmitting or receiving end, and a connecting portion extending into the inner bore of the elongated insulating member in a manner exposing the connecting portion as a center conductor of the antenna connector.

10. An antenna according to claim 9, further comprising a seal disposed on the transmitting or receiving end of the antenna body, the seal comprising a glass body having an aperture in surrounding relation to the element body.

11. An antenna according to claim 9, wherein the element body comprises Inconel.

12. An antenna according to claim 9, wherein the outer shell comprises a threaded surface.

13. An antenna according to claim 9, wherein the connective end comprises a receptacle area that has an inner threaded surface for engaging the outer shell.

14. A sensor comprising:
a controller responsive to an RF signal;
a cable coupled to the controller, the cable comprising a mating connector, and a conductor for conducting the RF signal between the controller and the mating connector; and
an antenna secured to the mating connector, the antenna comprising,
an antenna body having a transmitting or receiving end, a connective end opposite the transmitting or receiving end, and a longitudinal axis extending therebetween,
an antenna connector disposed on the connective end, the antenna connector for receiving the mating connector; and
a transmitting or receiving element aligned with the longitudinal axis, the transmitting or receiving element comprising an element body with a radiating portion extending out the transmitting or receiving end, and a connecting portion forming a center conductor of the antenna connector.

15. A sensor according to claim 12, wherein the center conductor of the antenna connector directly contacts the conductor of the cable.

16. A sensor according to claim 12, wherein the RF signal is conducted directly to the conductor of the cable via the element body.

17. A sensor according to claim 12, wherein antenna connector comprises an interface with a reverse polarity connector, the reverse polarity connector forming a male portion for receiving a female portion of the mating connector.

18. A sensor according to claim 12, wherein the element body comprises Inconel.

19. A sensor according to claim 12, wherein the connective end comprises a receptacle area that has an inner threaded surface for engaging the outer shell.

20. A sensor according to claim 12, wherein the element body comprises a nickel-chromium alloy.
